(19) United States
(12) Patent Application Publication
(10) Pub. No.: US 2006/0201965 A1
(43) Pub. Date: Sep. 14, 2006

(54) Coupling arrangement, coupling devices and use of coupling device

(76) Inventor: Sten Drennow, Lund (SE)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/330,618

(22) Filed: Jan. 12, 2006

(30) Foreign Application Priority Data
Mar. 11, 2005 (SE) 0500551-7

(51) Int. Cl. B67D 5/00

(52) U.S. Cl. 222/83

(57) ABSTRACT

A coupling arrangement (5) includes an inner coupling device (9) within a package (1) and an outer coupling device (12) on a withdrawal arrangement (4). The outer coupling device (12) includes a tube section (14) that can break a wall of a package (1) and be introduced into a hole (15) in a part (10) of the inner coupling device (9). At least one protruding part (16) is arranged on and/or beside the tube section (14) of the outer coupling device (12). At least one hole (17) and/or a thin section (18) of wall is arranged in the part (10) of the inner coupling device (9). The protruding part (16) can be introduced into the hole (17) and/or break the thin section (18) of wall, in order to allow coupling of the outer coupling device (12) and the inner coupling device (9). The protruding part (16) may prevent coupling of the inner coupling device (9) and the outer coupling device (12) if the part (10) provided with holes lacks the hole (17) and the thin section (18).

### FIELD OF THE INVENTION

The present invention relates to a coupling arrangement for coupling of a withdrawal arrangement to a package with liquid contents, through which withdrawal arrangement the contents are to be withdrawn from the package. The package consists, at least to a significant degree, of synthetic materials. The coupling arrangement comprises an inner coupling device with a part that is provided with holes and that is arranged on the inner surface of an unbroken part of the wall of the package. The coupling arrangement also comprises an outer coupling device that is arranged on the withdrawal arrangement. The outer coupling device comprises a tube section with which the unbroken part of the package can be broken and that can be introduced into the hole in the part that is provided with holes in order to be coupled to this part such that the contents of the package can be withdrawn through the tube part. The invention relates also to coupling devices and the use of a coupling device.

### BACKGROUND OF THE INVENTION

Coupling arrangements of the type described in the introduction are known from the documents U.S. Pat. No. 4,603,793 and WO 2004//037667. These documents describe coupling devices of circular form or other coupling sections with simple forms, and they describe coupling devices with non-circular coupling sections with fairly complicated designs. The latter designs of the coupling sections are intended to prevent the connection of packages and withdrawal devices that are not associated with each other.

It has proved to be the case that there is a need for coupling devices that, despite being circular or other coupling sections that are of simple design, cannot or may not be connected to each other. Such coupling devices are not known.

### SUMMARY OF THE INVENTION

The aim of the present invention has been to remove this deficiency, and this has been achieved through the coupling arrangement named in the introduction principally comprising the characteristics that are made clear by the attached claims 1, 18 and 21.

The coupling devices can be coupled if the outer coupling device comprises a protruding part and the inner coupling device comprises at least one of a hole and a thin section of wall that the protruding part can be brought to interact with, while the coupling devices cannot be coupled if the inner coupling device lacks the said hole or the said thin section of wall. This means that a withdrawal arrangement of a particular design cannot be coupled to certain packages, and this eliminates the risk that withdrawal devices for the withdrawal of certain contents from certain packages can be erroneously used for the withdrawal of other contents from other packages. The inner coupling device can be used for the coupling of an outer coupling device that lacks a protruding part.

### BRIEF DESCRIPTION OF THE DRAWINGS

The invention will be described in more detail below with reference to the attached drawings, in which:

FIG. 1 shows in perspective views an inner and an outer coupling device according to the invention that are parts of a coupling arrangement and that are to be coupled,

FIG. 2 shows a side view of the outer coupling device according to FIG. 1,

FIG. 3 shows the coupling devices according to FIG. 1 in partial cross-section before coupling,

FIG. 4 shows the coupling devices according to FIG. 1 in partial cross-section during coupling,

FIG. 5 shows the coupling devices according to FIG. 1 in partial cross-section after coupling, and

FIG. 6 shows a side view of an alternative embodiment of the outer coupling device of the coupling arrangement according to the invention.

### DESCRIPTION OF EXAMPLE EMBODIMENTS

The drawings show part 1 of a package, the walls 2 of which consist fully or partially of synthetic material and which may be, for example, a plastic bag. The contents 3 of the package 1 are liquid or essentially liquid, and may consist of foodstuffs, such as, for example, ketchup, mustard, mayonnaise, dressing, or similar.

A withdrawal arrangement 4 is intended for the withdrawal of the contents 3 from the package 1 and a coupling arrangement 5 is intended to allow coupling of the withdrawal arrangement 4 to the package 1 such that the contents 3 of the package 1 can be withdrawn from the package.

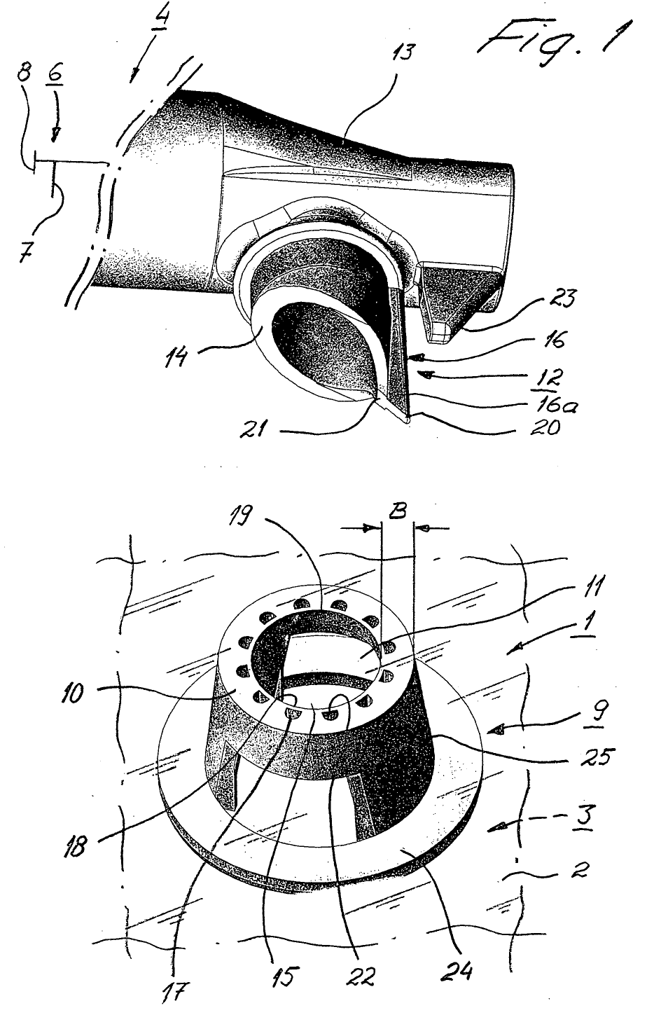

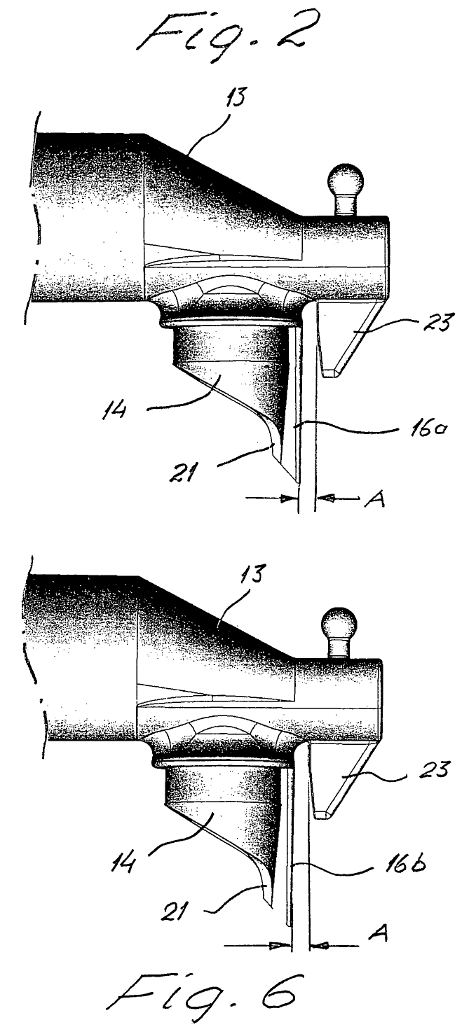

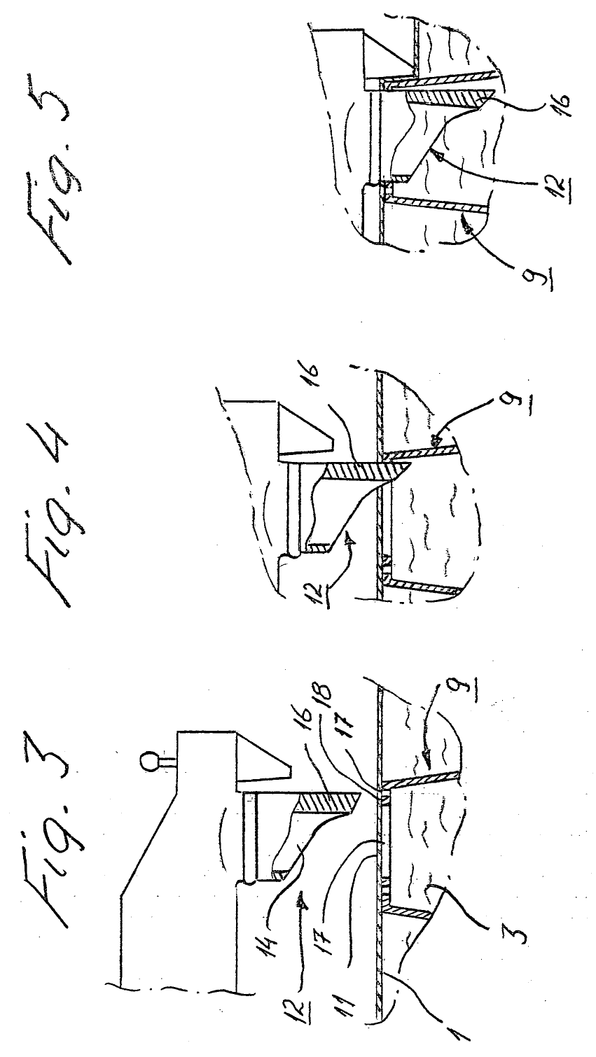

The withdrawal arrangement 4 may be a pump 6 that is partially shown in FIG. 1 and that may comprise an outlet tube 7 and a pump means 8 that can be operated manually. The pump 6 may be designed in known manner such that pumping actions of the pump means 8 withdraw contents 3 from the package 1 by suction and feed the contents out through the outlet tube 7.

The coupling arrangement 5 comprises an inner coupling device 9 that is arranged within the package 1 and that comprises a part 10 that is provided with holes, through which the inner coupling device 9 is arranged on the inner surface of an unbroken section 11 of wall of the walls 2 of the package 1.

The coupling arrangement 5 comprises furthermore an outer coupling device 12 that is arranged on the withdrawal arrangement 4, thus on the pump 6 in the design shown in the drawings. In more detail, the outer coupling device 12 is arranged on the lower part of a pump housing 13 that is part of the pump 6. The outer coupling device 12 comprises a tube section 14 with which the unbroken section 11 of the walls 2 of the package can be broken, and that can be introduced into a hole 15 in the part 10 that is provided with holes, in order to be coupled to this part such that the contents 3 of the package 1 can be withdrawn through the tube section 14.

When the unbroken part 11 of the wall is broken with the aid of the tube section 14, parts of the part 11 of the wall will be folded in into the hole 15 (these inwardly folded parts are not shown in the drawings), and the tube section 14 is pressed into the hole 15 to such an extent that it is in tight contact with the part 10 that is provided with holes.

At least one protruding part 16 is arranged on either the withdrawal arrangement 4, to be more precise at the pump housing 13 in the design that is shown in the drawings, or on the tube part 14, or on both. At least one hole 17 or at least one thin section 18 of wall, or both, is arranged in the part 10 that is provided with holes. When the coupling devices 9, 12 are coupled together, the protruding part 16 can break up the unbroken part 11 of wall outside of the hole 17 and this part can be either introduced into the hole 17 or caused to break up the thin section 18 of wall, or both, in order to allow the said coupling. If the part 10 that is provided with holes lacks both the said hole 17 and the thin section 18 of wall, the protruding part 16 will prevent the coupling devices 9, 12 from being coupled since it will come into contact with the part 10 that is provided with holes without the possibility of being able to pass through this part.

The hole 17 for the protruding part 16 is preferably arranged next to the edge 19 of the hole 15 in the part 10 that is provided with holes, and the thin section 18 of wall is preferably a section of wall between the hole 17 for the protruding part 16 and the said edge 19.

FIG. 2 makes it clear that the protruding part 16 can be a part 16a that is so integrated with the tube section 14 that it not only may be introduced into the hole 17 but also can be caused to break the thin section 18 of wall between the said hole 17 and the edge 19.

The part 16a can be designed as a flange that extends along at least significant parts of the outer surface of the tube section 14 and protrudes out in a radial direction from this tube section. The part 16a may, furthermore, comprise a point 20 that protrudes outwards in a direction forwards from the tube section 14, preferably forwards from such a pointed front edge 21 of this tube section that is intended to break the unbroken section 11 of wall.

The hole or holes 17 for the protruding part 16 may comprise any suitable shape, for example a circular shape, or the hole 17 can, as is shown in FIG. 1, comprise a straight edge 22 that faces the thin section 18 of wall. One or several holes 17 may be present, for example twelve such holes, and in the case in which there are several holes 17 these may be evenly distributed around the hole 15 or they may be distributed in another manner.

FIG. 6 makes it clear that it is an alternative that the protruding part 16 is a pin 16b that exits from the pump housing 13 and extends along the tube section 14 without being connected with this tube section. The pin 16b may be introduced into the hole 17 in the part 10 that is provided with holes in order to allow coupling of the coupling devices 9, 12.

Instead of holes 17 and thin sections 18 of wall, the part 10 that is provided with holes may comprise one or several other thin sections of wall (not shown in the drawings) that can be broken by the protruding part 16 independently of whether this is a part 16a that is connected with the tube section 14 or a pin 16b that is not connected with this tube section.

The pump housing 13 or equivalent may comprise at least one coupling preventing part 23 that is intended to prevent outer coupling devices 12 that comprise protruding parts 16 from being coupled to inner coupling devices that lack both holes 17 and thin sections 18 of wall for the protruding parts 16.

The coupling preventing part 23 is preferably arranged to prevent the introduction by force of an outer coupling device 12 with a protruding part 16 into the hole 15 in an inner coupling device 9 through the expansion of the part 10 that is provided with holes by force exerted by the tube section 14 and the protruding part 16. Thus, the coupling preventing part 23 is so arranged that it cannot pass the part 10 that is provided with holes if it is attempted to introduce the tube part 14 with the protruding part 16 into the hole 15 by force. The coupling preventing part 23 may be a protrusion or equivalent that protrudes from the pump housing 13 or equivalent and that extends along the tube section 14. The distance A between this coupling preventing part 23 and the protruding part 16 is preferably less than the width B of the part 10 that is provided with holes.

The coupling preventing part 23 is advantageous principally in the case in which the part 10 that is provided with holes consists of soft material whose shape can be changed by force with the aid of the outer coupling device 12 and the protruding piece 16.

FIG. 1 makes it clear that the inner coupling device 9 can consist of the part 10 that is provided with holes, which may be brought into contact with the unbroken part 11 of the wall 2 with the aid of a “plastic weld” or by another suitable means, and that may be a part with the shape of a ring with a hole 15 that is, for example, circular or essentially circular, while the tube section 14 has an equivalent shape. The inner coupling device 9 can, furthermore, comprise an inner part 24 with the shape of a ring and ribs 25 that connect this with the part 10 that is provided with holes.

The inner coupling device 9 can be used to couple to the same outer coupling device (not shown in the drawings), which comprises a tube section 14 that has a shape that is adapted to the shape of the hole 15 in the part 10 of the inner coupling device 9 that is provided with holes but that lacks one or more protruding parts 16. Several different coupling devices can in this way be coupled to the inner coupling device 9 while outer coupling devices with such forms that are to be totally prevented from being able to be coupled to the inner coupling device 9 are prevented from being coupled to it. For example, if the hole 15 of the inner coupling device 9 is circular, the outer coupling device may be cylindrical and lack protruding parts 16.

The invention is not limited to the design described above and shown in the drawings: it can vary within the framework of the attached patent claims. As examples that have not been described can be mentioned that the coupling devices 9, 12 may be arranged on other arrangements or packages than those described, the withdrawal arrangement may, for example, be a tube or a pipe instead of a pump, the protruding part of the outer coupling device may be designed or arranged in another way, and they may be designed in a different manner. Thus, there may be one or several protruding sections on the outer coupling device and there may be one or several holes in the outer coupling device for the protruding part. The withdrawal arrangement 4 can be a tap instead of a pump 6, out through which the contents 3 of the package 1 can flow when it is opened.

1. A coupling arrangement for coupling a withdrawal arrangement (4) to a package (1) with liquid or essentially liquid contents (3), which withdrawal arrangement (4) is intended for the withdrawal of the contents (3) from the package (1), wherein:
at least significant parts of the package (1) consist of synthetic material,
the coupling arrangement (5) comprises an inner coupling device (9) that is arranged within the package (1) and that comprises a part (10) that is provided with holes through which part it is arranged on the inner surface of an unbroken part (11) of wall of the walls (2) of the package (1),
the coupling arrangement (5) comprises an outer coupling device (12) that is arranged on the withdrawal arrangement (4), and
the outer coupling device (12) comprises a tube section (14) with which the unbroken part (11) of the wall of the package (1) can be broken and that can be introduced into the hole (15) in the part (10) of the inner coupling device (9) that is provided with holes in order to be coupled to this such that the contents (3) in the package (1) can be withdrawn through the tube section (14),
at least one protruding part (16) is arranged on the withdrawal arrangement (4) either on or beside, or both, the tube section (14) of the outer coupling device (12),
there is arranged in the part (10) of the inner coupling device (9) that is provided with holes in the package (1) at least one hole (17) or a thin section (18) of wall, or both,
the protruding part (16) can be either introduced into the said hole (17) or caused to break the thin section (18) of wall, or both, in order to allow coupling of the outer coupling device (12) and the inner coupling device (9), and
the protruding part (16) is arranged in interaction with the part (10) that is provided with holes to prevent coupling of the inner coupling device (9) and the outer coupling device (12) if the part (10) that is provided with holes lacks the said hole (17) and the said thin section (18) of wall for the protruding part (16).

2. The coupling arrangement according to claim 1, wherein:
the hole (17) for the protruding part (16) is arranged next to the edge (19) of the hole (15) in the part (10) that is provided with holes, and
the thin section (18) of wall is a section of wall between the hole (17) for the protruding part (16) and the said edge (19).

3. The coupling arrangement according to claim 1, wherein the protruding part (16) is a part (16a) that is so connected to the tube section (14) that it can not only be introduced into the hole (17) that is intended for it but also be caused to break a thin section (18) of wall between the said hole (17) and an edge (19) of the hole (15) in the part (10) that is provided with holes.

4. The coupling arrangement according to claim 3, wherein the protruding part (16) protrudes in a radial direction or an essentially radial direction from the tube section (14).

5. The coupling arrangement according to claim 3, wherein the protruding part (16) comprises a point (20) that is arranged to protrude in a direction forwards from the tube section (14).

6. The coupling arrangement according to claim 5, wherein the point (20) is arranged to protrude from such a pointed front edge (21) of the tube section (14) that is intended to break the unbroken section (11) of wall.

7. The coupling arrangement according to claim 3, wherein the protruding part (16) extends externally along at least significant parts of the tube section (14).

8. The coupling arrangement according to claim 3, wherein the hole (17) for the protruding part (16) comprises a straight edge (22) that is turned to face the thin section (18) of wall.

9. The coupling arrangement according to claim 1, wherein several holes (17) are available for the protruding part (16).

10. The coupling arrangement according to claim 1, wherein at least one coupling preventing part (23) is arranged to prevent the inner coupling device (9) and the outer coupling device (12) from being coupled together if the outer coupling device (12) comprises a protruding part (16) and if the tube section (14) and this protruding part (16) are pressed by force into the hole (15) in the part (10) of the inner coupling device (9) that is provided with holes.

11. The coupling arrangement according to claim 10, wherein:
the coupling preventing part (23) is a part arranged on the outer coupling device (23), and
the distance (A) between the coupling preventing part (23) and the protruding part (16) is less than the width (B) of the part (10) that is provided with holes.

12. The coupling arrangement according to claim 1, wherein the outer coupling device (12) is arranged at or consists of a part of a pump housing (13) for a pump (6) with which the contents (3) can be pumped out of the package (1).

13. The coupling arrangement according to claim 1, wherein:
the hole (15) in the part (10) that is provided with holes is circular or essentially circular, and
the tube section (14) has a shape that essentially corresponds to this.

14. The coupling arrangement according to claim 1, wherein at least the inner coupling device (9) consists of synthetic material.

15. The coupling arrangement according to claim 1, wherein the contents of the package (1) are liquid or half-liquid foodstuffs, such as, for example, ketchup, mustard, mayonnaise, dressing or similar.

16. The coupling arrangement according to claim 1, wherein the package (1) is a plastic bag.

17. The coupling arrangement according to claim 1, wherein the inner coupling device (9) comprises an inner part (24) with the shape of a ring that is coupled to the part (10) that is provided with holes.

18. Coupling devices for the coupling of a withdrawal arrangement (4) to a package (1) from which the contents (3) are to be withdrawn with the aid of the withdrawal arrangement (4), wherein:
it is intended that one coupling device is arranged as an inner coupling device (9) within the package (1) within an unbroken section (11) of the wall (2) of the package (1), which inner coupling device (9) comprises a part (10) provided with holes having one hole (15), and
a second coupling device is an outer coupling device (12) that comprises a tube section (14) that is intended to break the unbroken part (11) of the wall (2) of the package (1) and to be coupled to the inner coupling device (9) by being introduced into the hole (15) in the part (10) of it that is provided with holes,
the part (10) of the inner coupling device (9) that is provided with holes comprises at least one hole (17) or a thin section (18) of wall, or both, and either into which hole (17) at least one protruding part (16) of the outer coupling device (12) can be introduced or which thin section (18) of wall can be broken by the said protruding part (16), and
either the hole (17) or the thin section (18) of wall for the protruding part (16), or both, is intended to allow that the protruding part (16) can be caused to pass the part (10) that is provided with holes in order to allow coupling together of the inner coupling device (9) and the outer coupling device (12).

19. The coupling devices according to claim 18, wherein the outer coupling device (12) interacts with at least one coupling preventing part (23) that is arranged to prevent the coupling together of the inner coupling device (9) and the outer coupling device (12) if the outer coupling device (12) comprises a protruding part (16) and if the tube section (14) and this protruding part (16) are pressed by force into the hole (15) in the part (10) provided with holes.

20. The coupling devices according to claim 19, wherein:
the coupling preventing part (23) is a part that is arranged next to the outer coupling device (12), and
the distance (A) between the coupling preventing part (23) and the protruding part (16) is less than the width (B) of the part (10) that is provided with holes.

21. The use of a coupling device in order to couple a withdrawal arrangement (4) to a package (1) from which the contents (3) are to be withdrawn with the aid of the withdrawal arrangement (4), wherein:
it is intended that the coupling device is to be arranged as an inner coupling device (9) within the package (1) within an unbroken section (11) of the wall (2) of the package (1), which inner coupling device (9) comprises a part (10) provided with holes having one hole (15),
a second coupling device can be coupled to the inner coupling device (9), which second coupling device is an outer coupling device (12) that comprises a tube section (14) that is intended to break the unbroken part (11) of the wall (2) of the package (1) and to be coupled to the inner coupling device (9) by being introduced into the hole (15) in the part (10) of it that is provided with holes,
the part (10) of the inner coupling device (9) that is provided with holes comprises at least one hole (17) or a thin section (18) of wall, or both, into which hole (17) at least one protruding part (16) of the outer coupling device (12) can be introduced or which this section (18) of wall can be broken by the said protruding part (16), or both,
either the hole (17) or the thin section (18) of wall, or both, is intended for the protruding part (16) such that it allows the protruding part (16) to be caused to pass the part (10) that is provided with holes in order to allow coupling together of the inner coupling device (9) and the outer coupling device (12), and
the inner coupling device (9) is used to couple such an outer coupling device to the same outer coupling device, which comprises a tube section (14) that fits together with the hole (15) in the part (10) of the inner coupling device (9) that is provided with holes but that lacks at least one protruding part (16).
